(19) United States
(12) Patent Application Publication
(10) Pub. No.: US 2007/0041767 A1
(43) Pub. Date: Feb. 22, 2007

(54) Image generating apparatus

(75) Inventor: Kunio Sawai, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/488,078

(22) Filed: Jul. 18, 2006

(30) Foreign Application Priority Data
Aug. 22, 2005 (JP) 2005-239553

(51) Int. Cl. B41J 2/32

(52) U.S. Cl. 400/120.16

(57) ABSTRACT

An image generating apparatus capable of improving printing quality by suppressing irregularity in force for pressing a thermal head, mounted with a radiator plate, against a platen roller in a direction perpendicular to a paper carrying direction is obtained. This image generating apparatus comprises the platen roller, the thermal head opposed to the platen roller, the radiator plate formed with a long hole extending in the direction perpendicular to the paper carrying direction and a press member pressing the thermal head against the platen roller by pressing the radiator plate.

### BACKGROUND OF THE INVENTION

1. Field of the Invention

The present invention relates to an image generating apparatus, and more particularly, it relates to an image generating apparatus comprising a thermal head.

2. Description of the Background Art

A thermal head including a thermal head substrate pressing a platen roller and a support member supporting the thermal head substrate is generally known as a thermal head mounted on an image generating apparatus such as a thermal transfer printer. For example, Japanese Patent Laying-Open No. 4-216069 (1992) discloses such a thermal head. A technique of radiating heat generated in a thermal head having a structure similar that of the thermal head disclosed in the aforementioned Japanese Patent Laying-Open No. 4-216069 by mounting a radiator plate on a support member is also known in general.

FIG. 11 is a perspective view showing the structure of a conventional thermal transfer printer (image generating apparatus) having a thermal head mounted with a radiator plate, and FIG. 12 is an exploded perspective view of a portion around the radiator plate of the conventional thermal transfer printer shown in FIG. 11. FIGS. 13 and 14 illustrate the conventional thermal transfer printer shown in FIG. 11 pressing the thermal head against the platen roller. The structure of the conventional thermal transfer printer is now described with reference to FIGS. 11 to 14.

In the conventional thermal transfer printer, a platen roller 103 mounted on a rotary shaft 102, a thermal head 104 (see FIG. 12), a radiator plate 105, a pair of rotating arms 106 and 107, a thermal head pressing mechanism portion 108 and a paper carrying mechanism portion 109 are provided in a chassis 101, as shown in FIG. 11. The thermal transfer printer shown in FIG. 11 carries a paper in a paper carrying direction A.

The chassis 101 has a bottom surface 101a and a pair of side surfaces 101b and 101c, as shown in FIGS. 11 and 13. A mounting portion 101d for the rotating arm 106 and mounting portions 101e and 101f for the paper carrying mechanism portion 109 are formed on the bottom surface 101a of the chassis 101. The mounting portions 101d and 101f of the chassis 101 are formed with holes 101g and 101h respectively. A motor 110 for the thermal head pressing mechanism portion 108 and another motor 111 for the paper carrying mechanism portion 109 are mounted on the outer side of the first side surface 101b of the chassis 101. The first and second side surfaces 101b and 101c of the chassis 101 are formed with holes 101i for the thermal head pressing mechanism portion 108 respectively. The second side surface 101c of the chassis 101 is formed with a hole 101j for the rotating arm 107. FIG. 13 omits the paper carrying mechanism portion 109, in order to simplify the illustration. As shown in FIGS. 11 and 14, the second side surface 101c of the chassis 101 is also formed with a hole 101k for an ink sheet cartridge 112 mounted with an ink sheet 112a. As shown in FIGS. 11 and 13, bearings 113 rotatably supporting the rotary shaft 102 are mounted on the first and second side surfaces 101b and 101c of the chassis 101 respectively.

As shown in FIG. 14, the thermal head 104 is opposed to the platen roller 103. This thermal head 104 includes a support member 114 and a thermal head substrate 115, as shown in FIGS. 12 and 14. The support member 114 is in the form of a rectangle, and provided with a threaded hole 114a on the upper surface thereof. The thermal head substrate 115 is mounted on the lower surface of the support member 114. The thermal head 104 is so arranged that the longer sides thereof extend toward a direction B (see FIG. 11) perpendicular to the paper carrying direction A. A print area F101 for performing printing on a paper 130 is formed between the thermal head 104 and the platen roller 103, as shown in FIG. 14.

As shown in FIGS. 12 and 14, the radiator plate 105 is mounted on the support member 114 to cover the upper surface of the thermal head 104 (support member 114). This radiator plate 105 has a portion 105a covering the upper surface of the thermal head 104, another portion 105b serving as an ink sheet guide and still another portion 105c mounted with the rotating arms 106 and 107. The portion 105a of the radiator plate 105 covering the upper surface of the thermal head 104 is provided with a mounting hole 105d on a region corresponding to the threaded hole 114a of the support member 114. The radiator plate 105 is screwed to the thermal head 104 from above through screws 116a.

The portion 105b of the radiator plate 105 serving as an ink sheet guide, provided on a first end of the radiator plate 105 in the paper carrying direction A, is formed by downwardly bending the first end of the radiator plate 105 perpendicularly to the upper surface of the thermal head 104. The portion 105c of the radiator plate 105 mounted with the rotating arms 106 and 107, provided on a second end of the radiator plate 105 in the paper carrying direction A, is formed by obliquely upwardly bending the second end of the radiator plate 105. This portion 105c of the radiator plate 105 is formed with a mounting hole 105e.

As shown in FIG. 12, support shafts 106a and 107a are provided on first forward ends of the rotating arms 106 and 107 respectively. The support shaft 106a for the rotating arm 106 is fitted into the hole 101g (see FIG. 13) of the chassis 101, so that the rotating arm 106 is rotatable about the support shaft 106a. The support shaft 107a for the rotating arm 107 is also fitted into the hole 101j (see FIG. 11) of the chassis 101, so that the rotating arm 107 is rotatable about the support shaft 107a. The rotating arm 106 has a mounting portion 106b formed with a threaded hole 106c. The rotating arm 107 also has a mounting portion 107b formed with a threaded hole 107c. The radiator plate 105 is screwed to the rotating arms 106 and 107 from above through screws 116b. An engaging portion 106d engaging with a second end 118b (see FIG. 11) of a rotating member 118 described later is provided on a second forward end of the rotating arm 106.

As shown in FIGS. 11 and 13, the thermal head pressing mechanism portion 108 includes a support rod 117, the rotating member 118, a cap 119 and a cam gear 120. Both ends of the support rod 117 are fitted into the holes 101i of the chassis 101. The rotating member 118 is rotatably mounted on the support rod 117. A first end 118a of the rotating member 118 protrudes in a prescribed direction, so that the cap 119 is mounted on the forward end of the first end 118a. The second end 118b of the rotating member 118 engages with the engaging portion 106d of the rotating arm 106. The second end 118b of the rotating member 118 is provided with a cam pin 118c engaging with a cam groove 120a of the cam gear 120. Driving force of the motor 110 is transmitted to the cam gear 120 through a gear (not shown).

When the rotating member 118 rotates along arrow C, the second end 118b thereof pushes up the engaging portion 106d of the rotating arm 106 thereby upwardly rotating the radiator plate 105 and the thermal head 104, as shown in FIGS. 11 and 14. When the rotating member 118 rotates along arrow D, on the other hand, the second end 118b thereof moves downward for downwardly rotating the radiator plate 105 and the thermal head 104. After the downward rotation of the thermal head 104, the rotating member 118 further rotates along arrow D so that the cap 119 presses the radiator plate 105 thereby pressing the thermal head 104 against the platen roller 103, as shown in FIGS. 13 and 14. Referring to FIGS. 13 and 14, the cap 119 presses the radiator plate 105 on a pressing point P101 where the former comes into contact with the latter in printing.

As shown in FIG. 11, the paper carrying mechanism portion 109 includes a feed roller 121, a press roller 122, a bearing 123, a rotating plate 124 and a helical tension spring 125. The bearing 123 is mounted on the mounting portion 101e and the second side surface 101c of the chassis 101, for rotatably supporting the feed roller 121. A region 121a having a projecting portion is formed on the surface of the feed roller 121. The rotating plate 124 is so mounted on the mounting portion 101e of the chassis 101 as to rotate about a fulcrum shaft 124a. The rotating plate 124 is provided on a first end thereof with a bearing 124b rotatably supporting the press roller 122. First and second ends of the helical tension spring 125 are mounted on a second end of the rotating plate 124 and the hole 101h of the chassis 101 respectively.

In the conventional thermal transfer printer shown in FIGS. 11 to 14, however, the radiator plate 105 mounted on the upper surface of the thermal head 104 serves as a reinforcing plate for the thermal head 104, and hence the thermal head 104 is disadvantageously harder to deflect than the platen roller 103 (rotary shaft 102). In other words, the portion 105b of the radiator plate 105, downwardly perpendicularly bent with respect to the portion 105a, has high flexural strength. Therefore, the thermal head 104 mounted with the radiator plate 105 is disadvantageously harder to deflect than the platen roller 103 (rotary shaft 102) due to the bent portion 105b of the radiator plate 105. If the thermal head 104 is harder to deflect than the platen roller 103 (rotary shaft 102), the rotary shaft 102 (platen roller 103) is more downwardly deflected than the thermal head 104 in a region F102 around a portion corresponding to the pressing point P101 when the cap 119 presses the radiator plate 105. Therefore, the force for pressing the thermal head 104 against the platen roller 103 in the region F102 around the portion corresponding to the pressing point P101 is disadvantageously weaker than that in the remaining region. Consequently, the force for pressing the thermal head 104 against the platen roller 103 is irregular in the direction B perpendicular to the paper carrying direction A, to disadvantageously result in reduction of printing quality.

### SUMMARY OF THE INVENTION

The present invention has been proposed in order to solve the aforementioned problems, and an object of the present invention is to provide an image generating apparatus capable of improving printing quality by suppressing irregularity in force for pressing a thermal head, mounted with a radiator plate, against a platen roller in a direction perpendicular to a paper carrying direction.

In order to attain the aforementioned object, an image generating apparatus according to a first aspect of the present invention comprises a platen roller mounted on a rotary shaft, a thermal head opposed to the platen roller, a radiator plate mounted on the thermal head to cover a surface of the thermal head opposite to the platen roller and formed with a long hole extending in a direction perpendicular to a paper carrying direction and a press member pressing the thermal head against the platen roller by pressing the radiator plate.

In the image generating apparatus according to the first aspect, as hereinabove described, the radiator plate mounted on the thermal head is formed with the long hole extending in the direction perpendicular to the paper carrying direction for reducing flexural strength of the radiator plate, whereby the radiator plate is easily deflectable. Thus, the thermal head can be inhibited from disadvantageously plunging into a hardly deflectable state, despite the radiator plate mounted on the surface of the thermal head opposite to the platen roller. In this case, the press member presses the radiator plate formed with the long hole thereby pressing the thermal head against the platen roller, so that the thermal head can be deflected similarly to the rotary shaft when the rotary shaft mounted with the platen roller is deflected in the vicinity of a region corresponding to a point pressed by the press member. Thus, the force for pressing the thermal head against the platen roller in the vicinity of the region corresponding to the point pressed by the press member can be inhibited from reducing below that in the remaining region. Consequently, the force for pressing the thermal head against the platen roller can be inhibited from irregularity in the direction perpendicular to the paper carrying direction, whereby printing quality can be improved.

In the aforementioned image generating apparatus according to the first aspect, the thermal head is preferably opposed to the platen roller through an ink sheet, the radiator plate preferably has an ink sheet guide portion formed by bending a first end in the paper carrying direction toward the platen roller, and the long hole of the radiator plate is preferably formed on a bent region of the first end of the radiator plate in the paper carrying direction. According to this structure, the size of the bent region having high flexural strength is reduced by the size of the region formed with the long hole in the radiator plate having the ink sheet guide portion formed by bending the first end in the paper carrying direction toward the platen roller, whereby the flexural strength of the overall radiator plate can be reduced.

In this case, a first longer side of the long hole of the radiator plate is preferably arranged on an unbent portion of the radiator plate, and a second longer side of the long hole of the radiator plate is preferably arranged on the ink sheet guide portion of the radiator plate. According to this structure, the long hole of the radiator plate can be easily formed on the bent region of the first end of the radiator plate in the paper carrying direction.

In the aforementioned image generating apparatus according to the first aspect, the press member preferably presses an upper surface portion of the radiator plate around the long hole. According to this structure, the thermal head mounted with the radiator plate can be easily deflected similarly to the rotary shaft when the rotary shaft mounted with the platen roller is deflected since the upper surface portion of the radiator plate around the long hole is easier to deflect than the remaining portion of the radiator plate.

In the aforementioned image generating apparatus having the press member pressing the upper surface portion of the radiator plate around the long hole, the press member preferably presses the thermal head against the platen roller by pressing a point of the upper surface portion of the radiator plate around the center of the long hole. According to this structure, the radiator plate can be rendered easily deflectable when the press member presses the point around the center of the radiator plate since the upper surface portion of the radiator plate around the center of the long hole is easier to deflect than the remaining portion of the radiator plate.

In the aforementioned image generating apparatus having the press member pressing the upper surface portion of the radiator plate around the long hole, a portion of the radiator plate opposite to the side formed with the long hole is preferably bent, and the press member preferably presses the upper surface portion of the radiator plate separated from the bent portion opposite to the side formed with the long hole at a prescribed distance. According to this structure, the radiator plate can be rendered more easily deflectable since the upper surface portion separated from the bent portion is easier to deflect than another upper surface portion around the bent portion.

In the aforementioned image generating apparatus according to the first aspect, the length of the long hole of the radiator plate in the direction perpendicular to the paper carrying direction is preferably larger than half of the length of the radiator plate in the direction perpendicular to the paper carrying direction. According to this structure, the region of the radiator plate formed with the long hole can be increased in size, thereby reducing the flexural strength of the radiator plate.

In this case, both ends of the long hole of the radiator plate in the direction perpendicular to the paper carrying direction are preferably arranged in the vicinity of both ends of the radiator plate in the direction perpendicular to the paper carrying direction respectively. According to this structure, the region of the radiator plate formed with the long hole can be more increased in size, thereby more reducing the flexural strength of the radiator plate.

In the aforementioned image generating apparatus according to the first aspect, the long hole of the radiator plate is preferably singly formed to extend in the direction perpendicular to the paper carrying direction. According to this structure, the radiator plate can be rendered more easily deflectable as compared with a case of forming a plurality of long holes aligned in the direction perpendicular to the paper carrying direction on the radiator plate.

In the aforementioned image generating apparatus according to the first aspect, the long hole is preferably formed on a region of the radiator plate other than another region corresponding to the upper surface of the thermal head. According to this structure, the contact area between the thermal head and the radiator plate can be inhibited from reduction, whereby the image generating apparatus can be inhibited from reduction of heat radiability.

In the aforementioned image generating apparatus according to the first aspect, the radiator plate and the thermal head are preferably made of aluminum. According to this structure, the radiator plate and the thermal head can be relatively reduced in flexural strength, whereby the radiator plate as well as the thermal head can be easily deflected similarly to the rotary shaft when the rotary shaft is deflected.

An image generating apparatus according to a second aspect of the present invention comprises a platen roller mounted on a rotary shaft, a thermal head opposed to the platen roller through an ink sheet, a radiator plate, mounted on the thermal head to cover a surface of the thermal head opposite to the platen roller, having an ink sheet guide portion formed by bending a first end in a paper carrying direction toward the platen roller and a press member pressing the thermal head against the platen roller by pressing a point of the radiator plate. A long hole extending in a direction perpendicular to the paper carrying direction is formed on a bent region of the first end of the radiator plate in the paper carrying direction, and the press member presses a point of an upper surface portion of the radiator plate around the center of the long hole.

In the image generating apparatus according to the second aspect, as hereinabove described, the radiator plate mounted on the thermal head is formed with the long hole extending in the direction perpendicular to the paper carrying direction for reducing flexural strength of the radiator plate, whereby the radiator plate is easily deflectable. Thus, the thermal head can be inhibited from disadvantageously plunging into a hardly deflectable state, despite the radiator plate mounted on the surface of the thermal head opposite to the platen roller. In this case, the press member presses the radiator plate formed with the long hole thereby pressing the thermal head against the platen roller, so that the thermal head can be deflected similarly to the rotary shaft when the rotary shaft mounted with the platen roller is deflected in the vicinity of a region corresponding to a point pressed by the press member. Thus, the force for pressing the thermal head against the platen roller in the vicinity of the region corresponding to the point pressed by the press member can be inhibited from reducing below that in the remaining region. Consequently, the force for pressing the thermal head against the platen roller can be inhibited from irregularity in the direction perpendicular to the paper carrying direction, whereby printing quality can be improved. Further, the long hole is so formed on the bent region of the first end of the radiator plate in the paper carrying direction that the size of the bent region having high flexural strength is reduced by the size of the region formed with the long hole in the radiator plate having the ink sheet guide portion formed by bending the first end in the paper carrying direction toward the platen roller, whereby the flexural strength of the overall radiator plate can be reduced. In addition, the press member so presses the upper surface portion of the radiator plate around the long hole that the thermal head mounted with the radiator plate can be easily deflected similarly to the rotary shaft when the rotary shaft mounted with the platen roller is deflected since the upper surface portion of the radiator plate around the long hole is easier to deflect than the remaining portion of the radiator plate. In this case, the press member so presses the point of the upper surface portion of the radiator plate around the center of the long hole that the radiator plate can be rendered easily deflectable when the press member presses the point around the center of the radiator plate since the upper surface portion of the radiator plate around the center of the long hole is easier to deflect than the remaining portion of the radiator plate. Further, the long hole is singly formed on the radiator plate to extend in the direction perpendicular to the paper carrying direction, whereby the radiator plate can be rendered more easily deflectable as compared with a case of forming a plurality of long holes aligned in the direction perpendicular to the paper carrying direction on the radiator plate.

In the aforementioned image generating apparatus according to the second aspect, a first longer side of the long hole of the radiator plate is preferably arranged on an unbent portion of the radiator plate, and a second longer side of the long hole of the radiator plate is preferably arranged on the ink sheet guide portion of the radiator plate. According to this structure, the long hole of the radiator plate can be easily formed on the bent region of the first end of the radiator plate in the paper carrying direction.

In the aforementioned image generating apparatus according to the second aspect, a portion of the radiator plate opposite to the side formed with the long hole is preferably bent, and the press member preferably presses the upper surface portion of the radiator plate separated from the bent portion opposite to the side formed with the long hole at a prescribed distance. According to this structure, the radiator plate can be rendered more easily deflectable since the upper surface portion separated from the bent portion is easier to deflect than another upper surface portion around the bent portion.

In the aforementioned image generating apparatus according to the second aspect, the length of the long hole of the radiator plate in the direction perpendicular to the paper carrying direction is preferably larger than half of the length of the radiator plate in the direction perpendicular to the paper carrying direction. According to this structure, the region of the radiator plate formed with the long hole can be increased in size, thereby reducing the flexural strength of the radiator plate.

In this case, both ends of the long hole of the radiator plate in the direction perpendicular to the paper carrying direction are preferably arranged in the vicinity of both ends of the radiator plate in the direction perpendicular to the paper carrying direction respectively. According to this structure, the region of the radiator plate formed with the long hole can be more increased in size, thereby more reducing the flexural strength of the radiator plate.

In the aforementioned image generating apparatus according to the second aspect, the long hole is preferably formed on a region of the radiator plate other than another region corresponding to the upper surface of the thermal head. According to this structure, the contact area between the thermal head and the radiator plate can be inhibited from reduction, whereby the image generating apparatus can be inhibited from reduction of heat radiability.

In the aforementioned image generating apparatus according to the second aspect, the radiator plate and the thermal head are preferably made of aluminum. According to this structure, the radiator plate and the thermal head can be relatively reduced in flexural strength, whereby the radiator plate as well as the thermal head can be easily deflected similarly to the rotary shaft when the rotary shaft is deflected.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the structure of a thermal transfer printer according to an embodiment of the present invention;

FIG. 2 is a front elevational view of the thermal transfer printer according to the embodiment shown in FIG. 1;

FIG. 3 is a perspective view showing the thermal transfer printer according to the embodiment shown in FIG. 1 mounted with an ink cartridge;

FIG. 4 is an enlarged sectional view of a portion around a thermal head of the thermal transfer printer according to the embodiment shown in FIG. 1;

FIG. 5 is an exploded perspective view for illustrating the structure of a portion around a radiator plate of the thermal transfer printer according to the embodiment shown in FIG. 1;

FIG. 6 is a plan view of the radiator plate of the thermal transfer printer according to the embodiment shown in FIG. 1;

FIG. 7 is a front elevational view of the radiator plate of the thermal transfer printer according to the embodiment shown in FIG. 1;

FIG. 8 is a front elevational view of the thermal head of the thermal transfer printer according to the embodiment shown in FIG. 1, pressed against a platen roller;

FIG. 9 is an enlarged sectional view of the portion around the thermal head of the thermal transfer printer according to the embodiment shown in FIG. 1, pressed against the platen roller;

FIG. 10 is a graph showing results of chroma saturations measured in thermal transfer printers according to the embodiment of the present invention and comparative example respectively;

FIG. 11 is a perspective view showing the structure of a conventional thermal transfer printer having a thermal head mounted with a radiator plate;

FIG. 12 is an exploded perspective view of a portion around the radiator plate of the conventional thermal transfer printer shown in FIG. 11;

FIG. 13 is a front elevational view of the conventional thermal transfer printer shown in FIG. 11 with the thermal head pressed against a platen roller; and

FIG. 14 is an enlarged sectional view of a portion of the thermal head, pressed against the platen roller, of the conventional thermal transfer printer shown in FIG. 11.

### DESCRIPTION OF THE PREFERRED EMBODIMENTS

An embodiment of the present invention is now described with reference to the drawings.

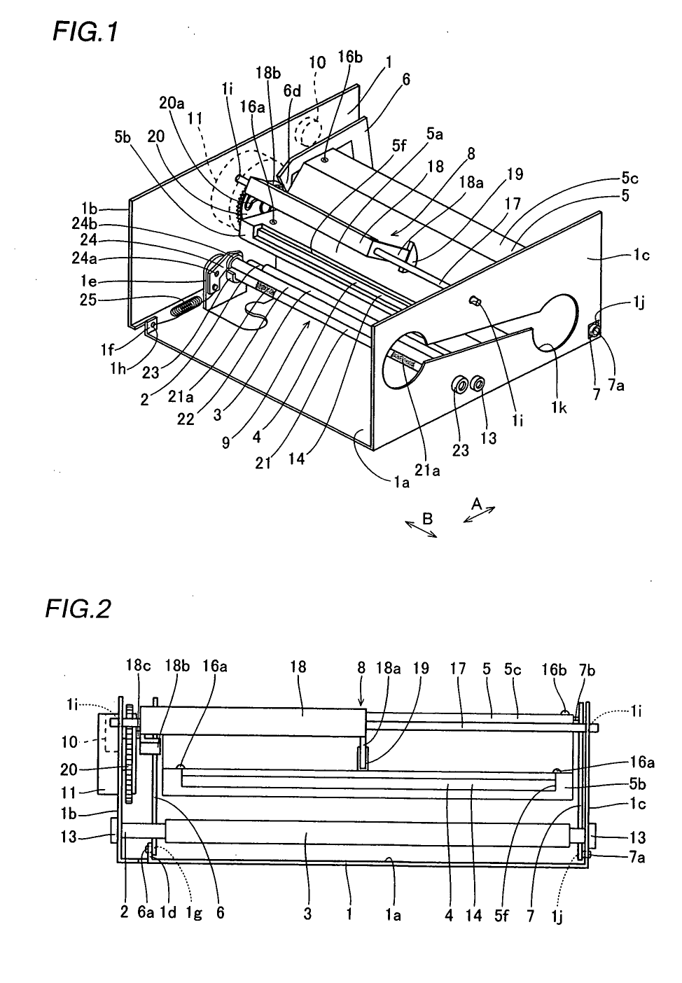

First, the structure of a thermal transfer printer according to this embodiment is described with reference to FIGS. 1 to 9.

In the thermal transfer printer according to this embodiment, a platen roller 3 mounted on a rotary shaft 2, a thermal head 4, a radiator plate 5, a pair of rotating arms 6 and 7, a thermal head pressing mechanism portion 8 and a paper carrying mechanism portion 9 are provided in a chassis 1, as shown in FIG. 1. The thermal transfer printer shown in FIG. 1 carries a paper in a paper carrying direction A.

As shown in FIGS. 1 and 2, the chassis 1 has a bottom surface 1a and a pair of side surfaces 1b and 1c formed by bending both ends of the bottom surface 1a in a direction B perpendicular to the paper carrying direction A perpendicularly to the bottom surface 1a. A mounting portion 1d for the rotating arm 6 and mounting portions 1e and 1f for the paper carrying mechanism portion 9 are formed on the bottom surface 1a to upwardly protrude from the bottom surface 1a respectively. These mounting portions 1d to 1f of the chassis 1 are formed by partially uprighting the bottom surface 1a. The mounting portions 1d and 1f of the chassis 1 are formed with holes 1g and 1h respectively. Motors 10 and 11 for the thermal head pressing mechanism portion 8 and the paper carrying mechanism portion 9 are mounted on the outer side of the first side surface 1b of the chassis 1. The first and second side surfaces 1b and 1c of the chassis 1 are formed with holes 1i for the thermal head pressing mechanism portion 8 respectively. The second side surface 1c of the chassis 1 is formed with a hole 1j for the rotating arm 7. FIG. 2 omits the paper carrying mechanism portion 9, in order to simplify the illustration.

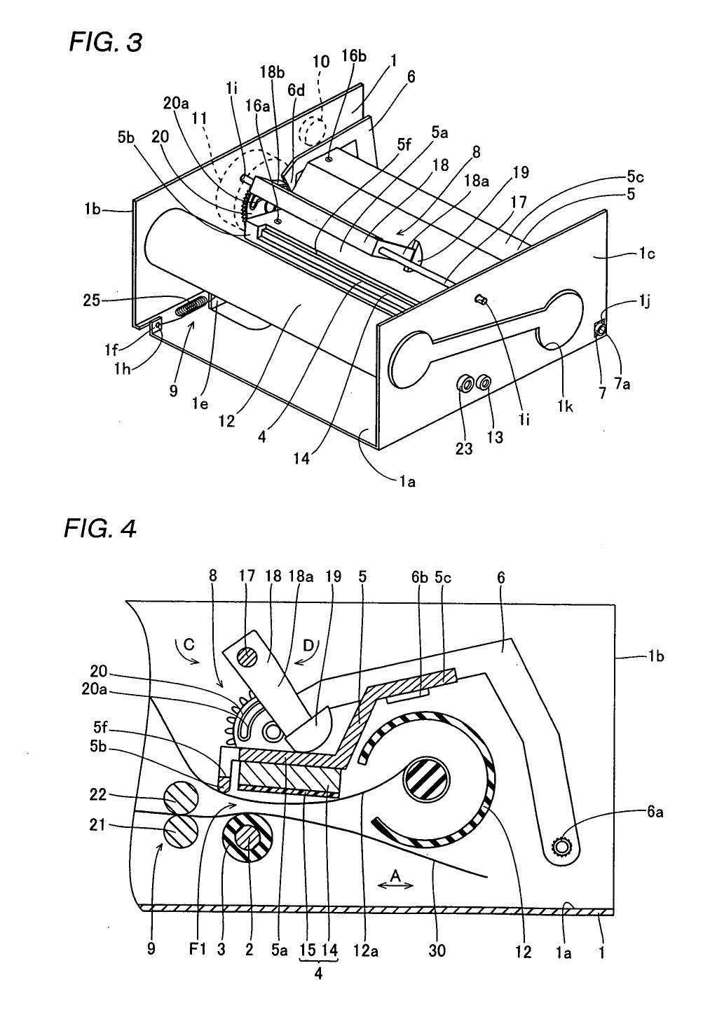

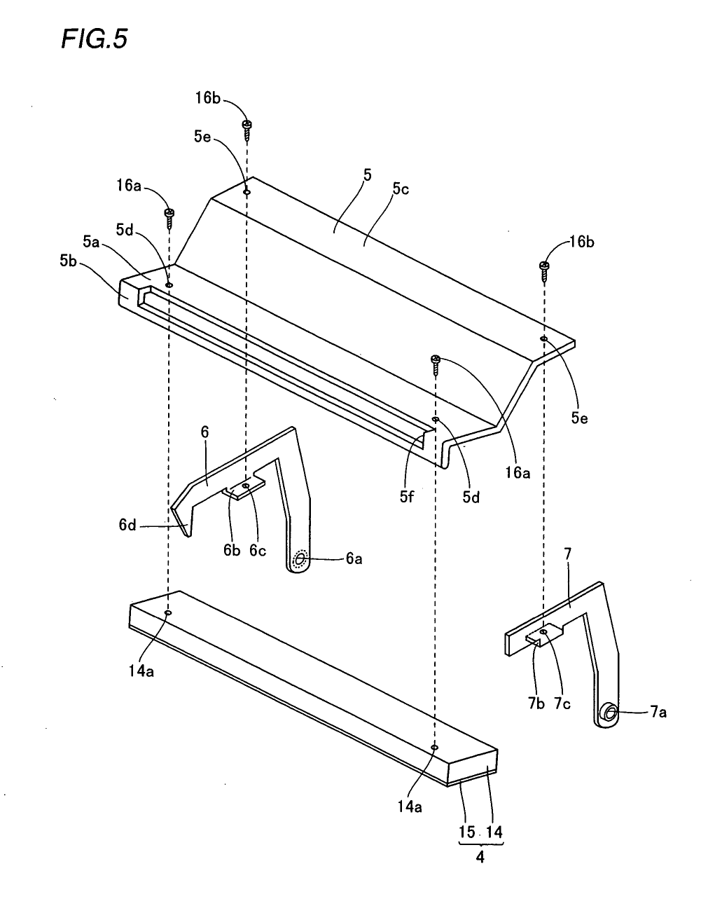

As shown in FIGS. 1 and 3, the second side surface 1c of the chassis 1 is formed with a hole 1k receiving an ink cartridge 12. The hole 1k of the chassis 1 receives the ink cartridge 12, thereby holding the same in the chassis 1. An ink sheet 12a is mounted on the ink sheet cartridge 12, as shown in FIG. 4.

As shown in FIGS. 1 and 2, bearings 13 for the rotary shaft 2 are mounted on the first and second side surfaces 1b and 1c of the chassis 1 respectively. The bearings 13 rotatably support the rotary shaft 2 mounted with the platen roller 3.

As shown in FIGS. 1 and 4, the thermal head 4 is opposed to the platen roller 3 from above the platen roller 3. This thermal head 4 includes a support member 14 and a thermal head substrate 15, as shown in FIGS. 4 and 5. The support member 14, made of a drawn material of aluminum having a thickness of about 4 mm, is in the form of a rectangle. A threaded hole 14a is formed on the upper surface of the support member 14. The thermal head substrate 15 is mounted on the lower surface of the support member 14. The thermal head 4 is so arranged that longer sides thereof extend toward the direction B (see FIG. 1) perpendicular to the paper carrying direction A. As shown in FIG. 4, the ink sheet 12a mounted on the ink cartridge 12 is arranged between the thermal head 4 (thermal head substrate 15) and the platen roller 3 on a print region F1 for performing printing on a paper 30.

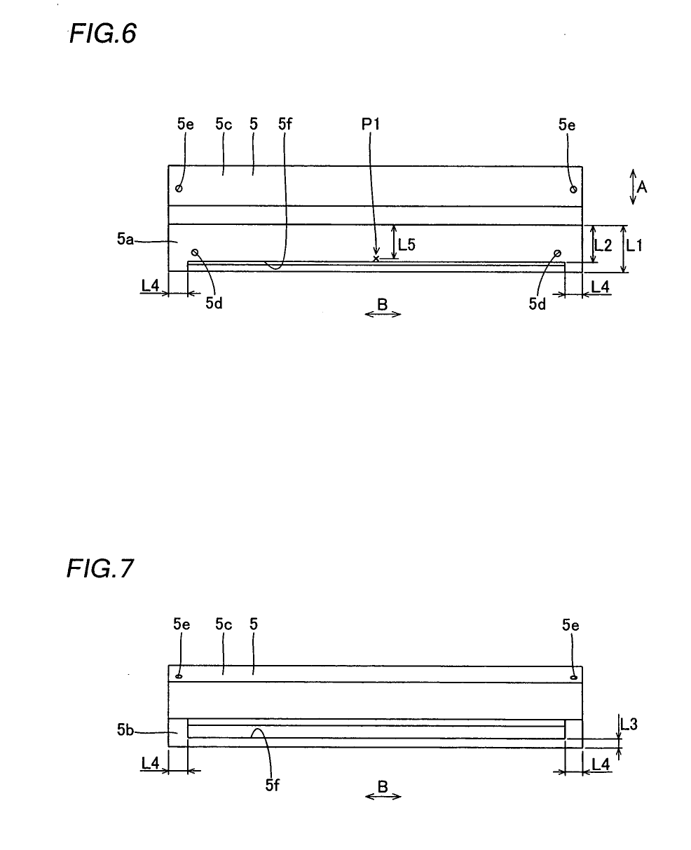

As shown in FIGS. 4 and 5, the radiator plate 5, formed by an aluminum plate having a thickness of about 2 mm, is mounted on the support member 14 to cover the upper surface of the thermal head 4 (support member 14). The radiator plate 5 has a portion 5a covering the upper surface of the thermal head 4, another portion 5b serving as an ink sheet guide and still another portion 5b mounted with the rotating arms 6 and 7. The portion 5b is an example of the “ink sheet guide portion” in the present invention. The portion 5a of the radiator plate 5 covering the upper surface of the thermal head 4 is formed with a mounting hole 5d on a region corresponding to the threaded hole 14a of the support member 14. The radiator plate 5 is screwed to the thermal head 4 from above through screws 16a. As shown in FIG. 6, the portion 5a of the heating plate 5 has a length L1 of about 22 mm in the paper carrying direction A.

As shown in FIGS. 4 and 5, the portion 5b of the radiator plate 5 serving as the ink sheet guide is formed on a first end of the radiator plate 5 in the paper carrying direction A by downwardly bending the first end of the radiator plate 5 perpendicularly to the upper surface of the thermal head 4. Further, the portion 5c of the radiator plate 5 mounted with the rotating arms 6 and 7 is formed on a second end of the radiator plate 5 in the paper carrying direction A by obliquely upwardly bending the second end of the radiator plate 5. This portion 5c of the radiator plate 5 is formed with a mounting hole 5e.

According to this embodiment, a long hole 5f extending in the direction B perpendicular to the paper carrying direction A is formed on a bent region of the first end of the radiator plate 5 in the paper carrying direction A (between the portions 5a and 5b of the radiator plate 5), as shown in FIGS. 5 to 7. First and second longer sides of the long hole 5f of the radiator plate 5 are arranged on the portions 5a and 5b of the radiator plate 5 respectively. The long hole 5f of the radiator plate 5 is formed on a region of the radiator plate 5 other than another region corresponding to the upper surface of the thermal head 4, as shown in FIG. 4. Thus, the contact area between the thermal head 4 and the radiator plate S can be inhibited from reduction, whereby the thermal transfer printer can be inhibited from reduction of heat radiability. Further, the length of the long hole 5f of the radiator plate 5 along the direction B is larger than half of the length of the radiator plate 5 along the direction B as shown in FIGS. 5 to 7, while both ends (shorter sides) of the long hole 5f of the radiator plate 5 along the direction B are arranged in the vicinity of both ends of the radiator plate 5 along the direction B respectively. More specifically, the first longer side of the long hole 5f of the radiator plate 5 is arranged at a distance L2 of about 19 mm from the boundary between the portions 5a and 5c of the radiator plate 5 while the second longer side of the long hole 5f is arranged at a distance L3 of about 3 mm from the lower end of the portion 5c of the radiator plate 5, as shown in FIGS. 6 and 7. Further, the shorter sides of the long hole 5f of the radiator plate 5 are arranged at a distance L4 of about 5 mm from an end surface of the radiator plate 5 in the direction B.

As shown in FIG. 5, support shafts 6a and 7a are provided on first forward ends of the rotating arms 6 and 7 respectively. The support shaft 6a for the rotating arm 6 is fitted into the hole 1g (see FIG. 2) of the chassis 1, so that the rotating arm 6 is rotatable about the support shaft 6a. The support shaft 7a for the rotating arm 7 is also fitted into the hole 1j (see FIG. 1) of the chassis 1, so that the rotating arm 7 is rotatable about the support shaft 7a. The rotating arm 6 has a mounting portion 6b formed with a threaded hole 6c. The rotating arm 7 also has a mounting portion 7b formed with a threaded hole 7c. The radiator plate 5 is screwed to the rotating arms 6 and 7 from above through screws 16b. Thus, the radiator plate 5 and the thermal head 4 are rotated upon rotation of the rotating arms 6 and 7. An engaging portion 6d engaging with a second end 18b (see FIG. 1) of a rotating member 18 described later is provided on a second forward end of the rotating arm 6.

As shown in FIGS. 1 and 2, the thermal head pressing mechanism portion 8 includes a support rod 17, a rotating member 18, a cap 19 of resin and a cam gear 20. The cap 19 is an example of the “press member” in the present invention. Both ends of the support rod 17 are fitted into the holes 1i of the chassis 1. The rotating member 18 is rotatably mounted on the support rod 17. A first end 18a of the rotating member 18 protrudes in a prescribed direction, so that the cap 19 is mounted on the forward end of the first end 18a. The second end 18b of the rotating member 18 engages with the engaging portion 6d of the rotating arm 6. The second end 18b of the rotating member 18 is provided with a cam pin 18c engaging with a cam groove 20a of the cam gear 20. Driving force of the motor 10 is transmitted to the cam gear 20 through a gear (not shown). In other words, the motor 10 is driven to rotate the cam gear 20, thereby rotating the rotating member 18.

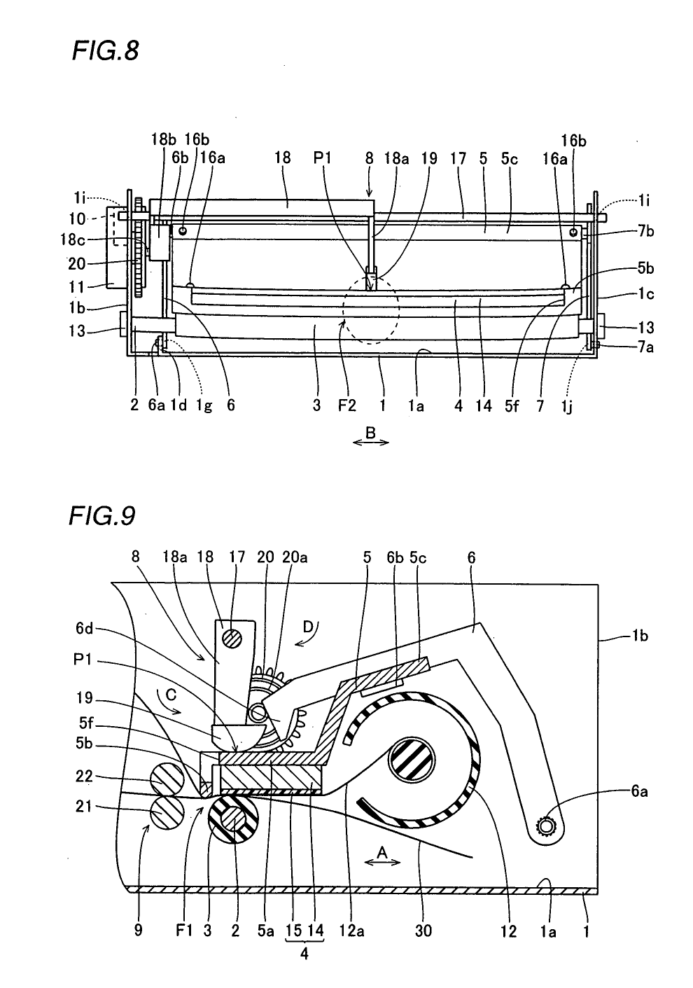

Thus, when the rotating member 18 rotates along arrow C, the second end 18b thereof pushes up the engaging portion 6d of the rotating arm 6 thereby upwardly rotating the radiator plate 5 and the thermal head 4, as shown in FIGS. 1 and 4. When the rotating member 18 rotates along arrow D, on the other hand, the second end 18b thereof moves downward for downwardly rotating the radiator plate 5 and the thermal head 4. After the downward rotation of the thermal head 4, the rotating member 18 further rotates along arrow D so that the cap 19 presses the radiator plate 5, thereby pressing the thermal head 4 against the platen roller 3 as shown in FIGS. 8 and 9. Referring to FIGS. 8 and 9, the cap 19 presses the radiator plate 5 on a pressing point P1 where the former comes into contact with the latter in printing.

According to this embodiment, the cap 19 (see FIG. 1) of the thermal head pressing mechanism portion 8 presses a point (pressing point P1) of the portion 5a of the heating plate 5 around the center of the long hole 5f in printing, as shown in FIG. 6. The distance L5 between the boundary between the portions 5a and 5c of the radiator plate 5 and the pressing point P1 is about 18 mm. Thus, the radiator plate 5 can be rendered easily deflectable since a portion around the pressing point P1 separated from the bent portion 5c of the radiator plate 5 by the prescribed distance (about 18 mm) is easier to deflect than a portion around the bent portion 5c.

As shown in FIG. 1, the paper carrying mechanism portion 9 includes a feed roller 21 of metal, a press roller 22 of metal, a bearing 23, a rotating plate 24 and a helical tension spring 25. The bearing 23 is mounted on the mounting portion 1e and the second side surface 1c of the chassis 1, for rotatably supporting the feed roller 21. A region 21a having a projecting portion prepared by rolling is formed on the surface of the feed roller 21. The press roller 22 is opposed to the feed roller 21 from above the feed roller 21. The rotating plate 24 is so mounted on the mounting portion 1e of the chassis 1 as to rotate about a fulcrum shaft 24a. The rotating plate 24 is provided on a first end thereof with a bearing 24b rotatably supporting the press roller 22. First and second ends of the helical tension spring 25 are mounted on a second end of the rotating plate 24 and the hole 1h of the chassis 1 respectively. This helical tension spring 25 has a function of urging the press roller 22 supported by the rotating plate 24 (bearing 24b) toward the feed roller 21. Another rotating plate 24 (not shown) and another helical tension spring 25 (not shown) are also mounted on the side surface 1c of the chassis 1.

A printing operation of the thermal transfer printer according to this embodiment is now described with reference to FIGS. 4, 8 and 9.

First, the thermal transfer printer carries a paper 30 to the print region F1 with the paper carrying mechanism 9 while separating the thermal head 4 from the platen roller 3, as shown in FIG. 4. Thereafter the thermal transfer printer rotates the rotating member 18 along arrow D, thereby downwardly moving the radiator plate 5 and the thermal head 4.

Then, the thermal transfer printer further rotates the rotating member 18 along arrow D after downwardly moving the thermal head 4, as shown in FIG. 9. Thus, the cap 19 presses the radiator plate 5 on the pressing point P1, thereby pressing the thermal head 4 against the platen roller 3. The cap 19 presses the radiator plate 5 with pressing force of about 5 kg.

According to this embodiment, the rotary shaft 2 mounted with the platen roller 3 deflects downward while the thermal head 4 and the radiator plate 5 also deflect similarly to the rotary shaft 2 in a region F2 around a portion corresponding to the pressing point P1 of the cap 19, as shown in FIG. 8. In other words, the platen roller 3 and the thermal head 4 are in close contact with each other through the ink sheet 12a and the paper 30 along the overall regions in the direction B perpendicular to the paper carrying direction A, as shown in FIGS. 8 and 9.

Thereafter the thermal transfer printer moves the paper 30 in the paper carrying direction A with the paper carrying mechanism portion 9 while pressing the thermal head 4 against the platen roller 3 thereby performing printing on the paper 30 on the print region F1, as shown in FIG. 9.

According to this embodiment, as hereinabove described, the radiator plate 5 mounted on the thermal head 4 (support member 14) is formed with the long hole 5f extending in the direction B perpendicular to the paper carrying direction A for reducing flexural strength of the radiator plate 5, so that the radiator plate 5 is easily deflectable. Thus, the thermal head 4 can be inhibited from disadvantageously plunging into a hardly deflectable state, despite the radiator plate 5 mounted on the surface of the thermal head 4 opposite to the platen roller 3. In this case, the thermal head pressing mechanism portion 8 (cap 19) presses the radiator plate 5 formed with the long hole 5f thereby pressing the thermal head 4 against the platen roller 3, so that the thermal head 4 can be deflected similarly to the rotary shaft 2 when the rotary shaft 2 mounted with the platen roller 3 is deflected in the region F2 around the portion corresponding to the pressing point P1 of the cap 19. Thus, the force for pressing the thermal head 4 against the platen roller 3 in the region F2 around the portion corresponding to the pressing point P1 of the cap 19 can be inhibited from reducing below that in the remaining region. Consequently, the force for pressing the thermal head 4 against the platen roller 3 can be inhibited from irregularity in the direction B perpendicular to the paper carrying direction A, whereby printing quality can be improved.

According to this embodiment, as hereinabove described, the long hole 5f is so formed on the bent region of the first end of the radiator plate 5 in the paper carrying direction A (between the portions 5a and 5b of the radiator plate 5) that the size of the bent region having high flexural strength is reduced by the size of the region formed with the long hole 5f, whereby the flexural strength of the overall radiator plate 5 can be reduced.

According to this embodiment, as hereinabove described, the thermal head pressing mechanism portion 8 (cap 19) so presses the portion 5a of the radiator plate 5 around the long hole 5h that the thermal head 4 mounted with the radiator plate 5 can be easily deflected similarly to the rotary shaft 2 when the rotary shaft 2 mounted with the platen roller 3 is deflected since the portion 5a of the radiator plate 5 around the long hole 5f is easier to deflect than the remaining portion of the radiator plate 5. In this case, the thermal head pressing mechanism portion 8 (cap 19) so presses the point of the portion 5a of the radiator plate 5 around the center of the long hole 5f that the radiator plate 5 can be rendered easily deflectable when the thermal head pressing mechanism portion 8 presses the point around the center of the radiator plate 5 since the portion 5a of the radiator plate 5 around the center of the long hole 5f is easier to deflect than the remaining portion of the radiator plate 5.

According to this embodiment, as hereinabove described, the long hole 5f is singly formed on the radiator plate 5 to extend in the direction B perpendicular to the paper carrying direction A, whereby the radiator plate 5 can be rendered more easily deflectable as compared with a case of forming a plurality of long holes aligned in the direction B perpendicular to the paper carrying direction A on the radiator plate 5.

According to this embodiment, as hereinabove described, both ends (shorter sides) of the long hole 5f of the radiator plate 5 in the direction B are arranged in the vicinity of both ends of the radiator plate 5 in the direction B respectively, whereby the region of the radiator plate 5 formed with the long hole 5f can be more increased in size, thereby more reducing the flexural strength of the radiator plate 5.

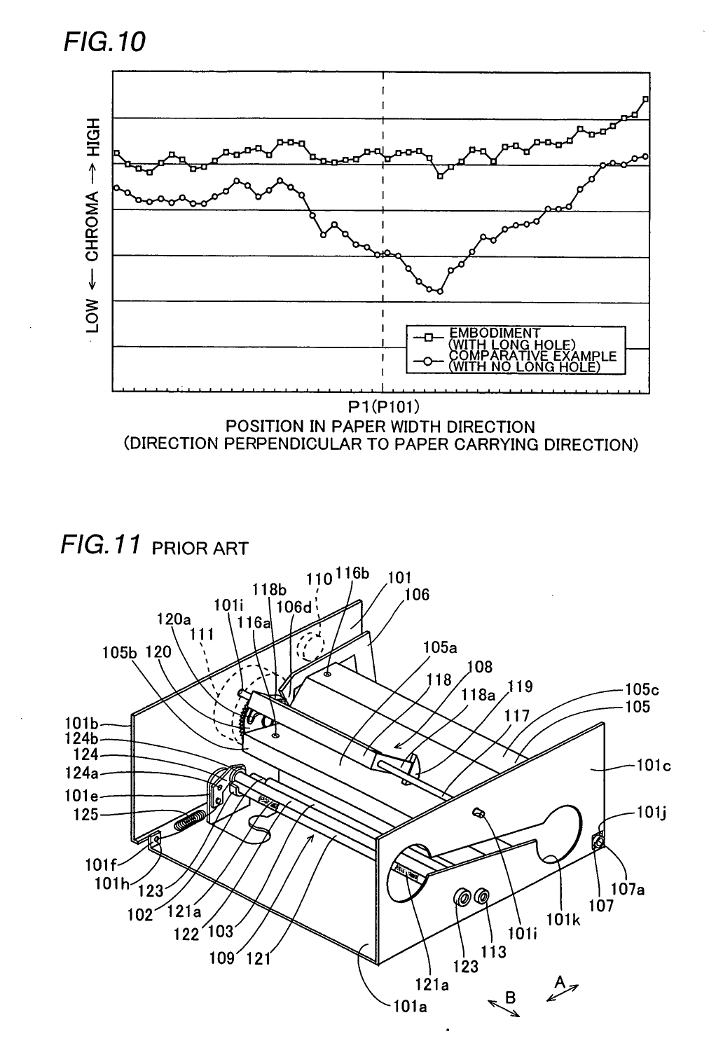

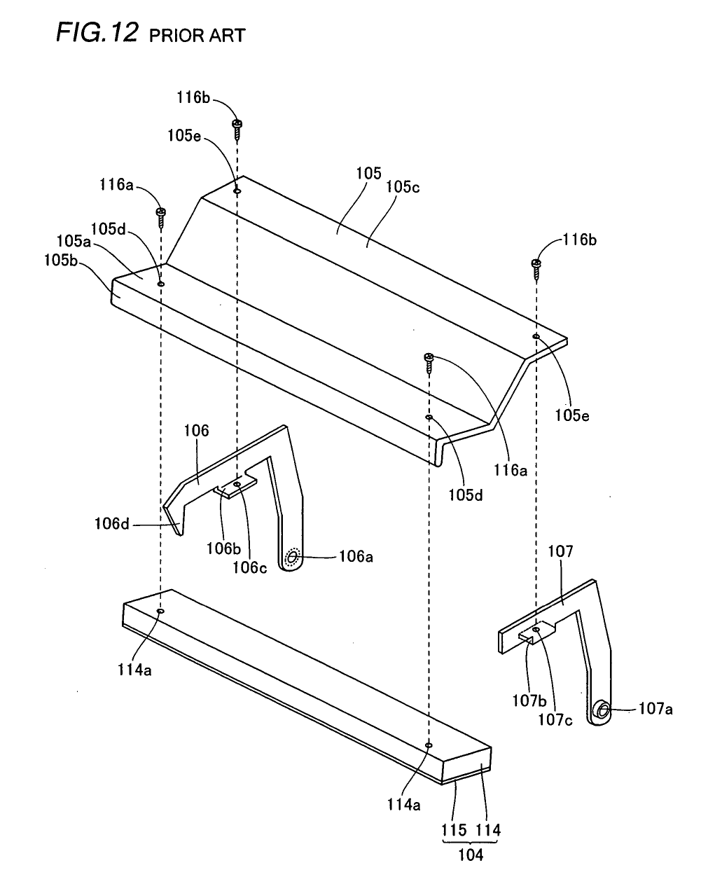

An experiment performed for confirming the aforementioned effect of improving printing quality is now described. In this confirmatory experiment, the thermal transfer printer (see FIG. 1) according to this embodiment having the heating plate 5 formed with the long hole 5f and the conventional thermal transfer printer (see FIG. 11), serving as comparative example, having the radiator plate 105 formed with no long hole were employed for performing printing on the papers 30 and 130 respectively. Chroma saturations of prints formed by the thermal transfer printers according to this embodiment and comparative example respectively were measured. FIG. 10 shows the results. FIG. 10 shows the chroma saturations (arbitrary unit) of the prints on the axis of ordinates, while showing positions of the printed papers 30 and 130 in the width direction (perpendicular to the paper carrying direction A). The broken line in FIG. 10 shows regions corresponding to the pressing points P101 and P1.

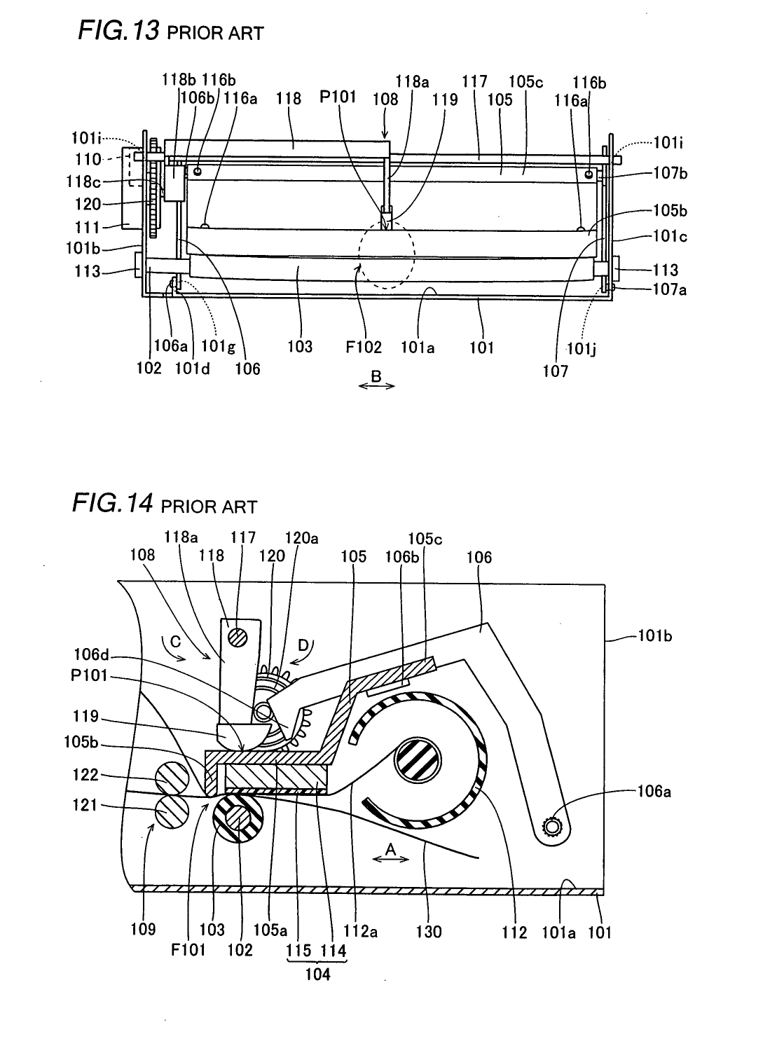

Referring to FIG. 10, it has been proved that dispersion of the chroma saturation in the width direction of the paper 30 is reduced in the thermal transfer printer according to this embodiment having the radiator plate 5 formed with the long hole 5f, as compared with the thermal transfer printer according to comparative example having the radiator plate 105 formed with no long hole. More specifically, the chroma saturation was hardly reduced in the region F2 (see FIG. 8) around the portion corresponding to the pressing point P1 in the thermal transfer printer according to this embodiment, while the chroma saturation was remarkably reduced in the region F102 (see FIG. 13) around the portion corresponding to the pressing point P101 in the thermal transfer printer according to comparative example. It has been confirmable from these results that the force for pressing the thermal head 4 against the platen roller 3 in the region F2 around the portion corresponding to the pressing point P1 is inhibited from reducing below that in the remaining region since the thermal head 4 is deflected similarly to the rotary shaft 2 (platen roller 3) in the region F2 around the portion corresponding to the pressing point P1 according to this embodiment.

Although the present invention has been described and illustrated in detail, it is clearly understood that the same is by way of illustration and example only and is not to be taken by way of limitation, the spirit and scope of the present invention being limited only by the terms of the appended claims.

For example, the present invention, applied to the thermal transfer printer in the aforementioned embodiment, is not restricted to this but is also applicable to an image generating apparatus such as a thermal transfer facsimile other than the thermal transfer printer.

While the thermal head 4 is arranged above the platen roller 3 in the aforementioned embodiment, the present invention is not restricted to this but the thermal head 4 may alternatively be arranged under the platen roller 3 to be pressed against the platen roller 3 from below.

While the radiator plate 5 has the ink sheet guide in the aforementioned embodiment, the present invention is not restricted to this but the radiator plate 5 and the ink sheet guide may alternatively be provided independently of each other.

While the thermal transfer printer rotates the rotating member 18 with the driving force of the motor 20 for pressing the radiator plate 5 with the cap 19 mounted on the rotating member 18 in the aforementioned embodiment, the present invention is not restricted to this but the thermal transfer printer may alternatively press the radiator plate 5 with urging force of a spring.

While the long hole 5f is formed on the bent region of the first end of the radiator plate 5 in the paper carrying direction A (between the portions 5a and 5b of the radiator plate 5) in the aforementioned embodiment, the present invention is not restricted to this but the long hole 5f may alternatively be formed only on the portion 5a of the radiator plate 5 covering the upper surface of the thermal head 4.

What is claimed is:

1. An image generating apparatus comprising:
a platen roller mounted on a rotary shaft;
a thermal head opposed to said platen roller;
a radiator plate mounted on said thermal head to cover a surface of said thermal head opposite to said platen roller and formed with a long hole extending in a direction perpendicular to a paper carrying direction; and
a press member pressing said thermal head against said platen roller by pressing said radiator plate.

2. The image generating apparatus according to claim 1, wherein
said thermal head is opposed to said platen roller through an ink sheet,
said radiator plate has an ink sheet guide portion formed by bending a first end in said paper carrying direction toward said platen roller, and
said long hole of said radiator plate is formed on a bent region of said first end of said radiator plate in said paper carrying direction.

3. The image generating apparatus according to claim 2, wherein
a first longer side of said long hole of said radiator plate is arranged on an unbent portion of said radiator plate, and
a second longer side of said long hole of said radiator plate is arranged on said ink sheet guide portion of said radiator plate.

4. The image generating apparatus according to claim 1, wherein
said press member presses an upper surface portion of said radiator plate around said long hole.

5. The image generating apparatus according to claim 4, wherein
said press member presses said thermal head against said platen roller by pressing a point of said upper surface portion of said radiator plate around the center of said long hole.

6. The image generating apparatus according to claim 4, wherein
a portion of said radiator plate opposite to the side formed with said long hole is bent, and
said press member presses said upper surface portion of said radiator plate separated from said bent portion opposite to the side formed with said long hole at a prescribed distance.

7. The image generating apparatus according to claim 1, wherein
the length of said long hole of said radiator plate in said direction perpendicular to said paper carrying direction is larger than half of the length of said radiator plate in said direction perpendicular to said paper carrying direction.

8. The image generating apparatus according to claim 7, wherein
both ends of said long hole of said radiator plate in said direction perpendicular to said paper carrying direction are arranged in the vicinity of both ends of said radiator plate in said direction perpendicular to said paper carrying direction respectively.

9. The image generating apparatus according to claim 1, wherein
said long hole of said radiator plate is singly formed to extend in said direction perpendicular to said paper carrying direction.

10. The image generating apparatus according to claim 1, wherein
said long hole is formed on a region of said radiator plate other than another region corresponding to the upper surface of said thermal head.

11. The image generating apparatus according to claim 1, wherein
said radiator plate and said thermal head are made of aluminum.

12. An image generating apparatus comprising:
a platen roller mounted on a rotary shaft;
a thermal head opposed to said platen roller through an ink sheet;
a radiator plate, mounted on said thermal head to cover a surface of said thermal head opposite to said platen roller, having an ink sheet guide portion formed by bending a first end in a paper carrying direction toward said platen roller; and
a press member pressing said thermal head against said platen roller by pressing a point of said radiator plate, wherein
a long hole extending in a direction perpendicular to said paper carrying direction is formed on a bent region of said first end of said radiator plate in said paper carrying direction, and
said press member presses a point of an upper surface portion of said radiator plate around the center of said long hole.

13. The image generating apparatus according to claim 12, wherein
a first longer side of said long hole of said radiator plate is arranged on an unbent portion of said radiator plate, and
a second longer side of said long hole of said radiator plate is arranged on said ink sheet guide portion of said radiator plate.

14. The image generating apparatus according to claim 12, wherein
a portion of said radiator plate opposite to the side formed with said long hole is bent, and
said press member presses said upper surface portion of said radiator plate separated from said bent portion opposite to the side formed with said long hole at a prescribed distance.

15. The image generating apparatus according to claim 12, wherein
the length of said long hole of said radiator plate in said direction perpendicular to said paper carrying direction is larger than half of the length of said radiator plate in said direction perpendicular to said paper carrying direction.

16. The image generating apparatus according to claim 15, wherein
both ends of said long hole of said radiator plate in said direction perpendicular to said paper carrying direction are arranged in the vicinity of both ends of said radiator plate in said direction perpendicular to said paper carrying direction respectively.

17. The image generating apparatus according to claim 12, wherein
said long hole is formed on a region of said radiator plate other than another region corresponding to the upper surface of said thermal head.

18. The image generating apparatus according to claim 12, wherein
said radiator plate and said thermal head are made of aluminum.
